(19) United States
(12) Patent Application Publication
(10) Pub. No.: US 2006/0178969 A1
(43) Pub. Date: Aug. 10, 2006

(54) Methods for giving a gift and systems thereof

(75) Inventors: Nicolas Caillens, New York, NY (US); Jerome Chasques, New York, NY (US)

Correspondence Address: NIXON PEABODY LLP - PATENT GROUP, CLINTON SQUARE, P.O. BOX 31051, ROCHESTER, NY, 14603-1051, US

(73) Assignee: Sogifty Publishing LLC, New York, NY (US)

(21) Appl. No.: 11/280,501

(22) Filed: Nov. 16, 2005

Related U.S. Application Data
(60) Provisional application No. 60/628,312, filed on Nov. 16, 2004.

(51) Int. Cl. G06Q 40/00

(52) U.S. Cl. 705/35

(57) ABSTRACT

A method for gift giving includes offering a selection of at least one of a plurality of primary gifts within a set and a selection of one or more secondary gifts. The monetary value of each of the primary gifts and each of the secondary gifts is not specified. Each of the secondary gifts is associated with one of the primary gifts. At least one of the plurality of primary gifts is selected from within the set and one or more of the secondary gifts from within the set which were not associated with the selected for the primary gift are selected. The selected primary gift and each of the one or more of the selected secondary gifts are provided.

### FIELD OF THE INVENTION

This application claims the benefit of U.S. Provisional Patent Application Ser. No. 60/628,312, filed Nov. 16, 2004, which is herein incorporated by reference in its entirety.

### FIELD OF THE INVENTION

This invention generally relates to methods and systems for giving a gift and, more particularly, to methods for providing and selecting a gift from a plurality of gifts in a set with a non-listed monetary value and systems thereof.

### BACKGROUND

Traditionally, prior gift card methods and systems have consisted of a gift giver purchasing a gift card for a specified monetary value for use at a particular establishment. Other gift card methods and systems have allowed the gift giver to purchase a gift card for use in one of a variety of establishments, such as within one of all of the stores within a designated mall.

Unfortunately, with the gift card with a specified monetary value, the recipient would almost never be able to find an item or items at the designated establishment for the specified monetary value of the gift card. If the desired purchase was less than the specified monetary value, the gift recipient would sometimes feel the need to find another item to purchase, which might not really be desired and would require an additional out of pocket expense, or would have to leave a portion of the monetary value not spent on the gift card which often would end up being unused. In either scenario, this experience could leave the recipient with a negative impression or feeling about the designated establishment, instead of a positive feeling about the experience which might foster further business.

Another problem with the gift card with a specified monetary value is that the recipient would know the exact amount spent by the gift giver. In certain gift giving situations, the gift giver may not want the recipient to be aware of the exact value of the gift.

Further, these prior gift giving methods and systems provided little, if any, information about the products and/or services of the establishment providing the gift. Additionally, these prior gift giving methods and systems do not provide information about other establishments which provides similar products and/or services or do anything to facilitate or to provide an incentive to explore and shop at the other establishments.

### SUMMARY

A method for gift giving in accordance with embodiments of the present invention includes offering a selection of at least one of a plurality of primary gifts within a set and a selection of one or more secondary gifts. The monetary value of each of the primary gifts and each of the secondary gifts is not specified. Each of the secondary gifts is associated with one of the primary gifts. At least one of the plurality of primary gifts is selected from within the set and one or more of the secondary gifts from within the set which were not associated with the selected for the primary gift are selected. The selected primary gift and each of the one or more of the selected secondary gifts are provided.

A system for gift giving in accordance with other embodiments of the present invention includes an offering system, a processing system, and an indicator system. The offering system offers a selection of at least one of a plurality of primary gifts within a set and a guide book with a description of each of the primary gifts. A monetary value of each of the primary gifts is not specified. The processing system receives the selection of at least one of the plurality of primary gifts based on the description in the guide book and determines if any of the selected primary gifts has already been provided. The indicator system provides an indication that the selected at least one of the primary gifts can be provided based on the determination by the processing system that none of the primary gifts has been provided.

A method for gift giving in accordance with other embodiments of the present invention includes offering a selection of at least one of a plurality of primary gifts within a set and a guide book with a description of each of the primary gifts. A monetary value of each of the primary gifts is not specified. At least one of the plurality of primary gifts is selected from within the set based on the description of each of the primary gifts in the guide book and then is provided.

The present invention provides a number of advantages including providing a method and system for giving a gift which provides a unique and satisfying gift giving experience for the recipient of a primary and one or more secondary gifts. With the present invention, the gift recipient can obtain a desired gift without the hassle and inconvenience of trying to find a gift which corresponds directly with the specified monetary amount, but instead is simply left with a positive gift receiving experience. Additionally, the gift giver can provide the gifts without having to disclose their specified monetary value.

The present invention also helps to advertise the products and/or services of each of the potential providers of the gift. Information about each of the primary and secondary gifts is conveniently provided in a guide book with the offered gift. This makes it easy for the user to peruse the possible primary and secondary gift experiences without the need for additional research about any of the gifts. Additionally, these descriptions in the guide book increase the market visibility and sales of the provider or providers of the primary and secondary gifts. Accordingly, the present invention helps to promote business.

The present invention also provides the option to renew or extend the additional gift for an additional purchase. This enables the gift recipient to experience another primary and/or secondary gift and further helps to promote the business of the providers of these gifts.

### BRIEF DESCRIPTION OF THE DRAWINGS

FIG. 1 is a block diagram of a system for giving gifts in accordance with embodiments of the present invention;

FIG. 2 is a front view of a gift certificate for the system shown in FIG. 1;

FIG. 3 is a front view of a page in the guide book which describes a primary gift and a secondary gift at each provider;

FIG. 4 is a front view of a cover page and a table of contents page in the guide book shown in FIG. 3;

FIG. 5 is a front view of a cover page and a selection page in another guide book;

FIG. 6 is a front view of inside a cover of the gift box with an experience enhancing product;

FIG. 7 is a front view of a membership card in the gift box shown in FIG. 6;

FIG. 8 is a screen shot of a web page used to activate a gift certificate in the system for giving gifts;

FIG. 9 is a screen shot of a web page used to indicate in the system for giving gifts that the gift certificate has been activated and a listing of available sets of primary gifts that can be selected;

FIG. 10 is a screen shot of a list of the primary gifts available within a Kids Activities gift package;

FIG. 11 is back view of a gift box with a list of the primary gifts available within a Kids Activities gift package;

FIG. 12 is back view of a gift box with a list of the primary gifts available within a New York Classes gift package;

FIG. 13 is back view of a gift box with a list of the primary gifts available within a Chocolate Addiction gift package; and

FIG. 14 is a flow chart of a method for providing and selecting gifts in accordance with embodiments of the present invention.

### DETAILED DESCRIPTION

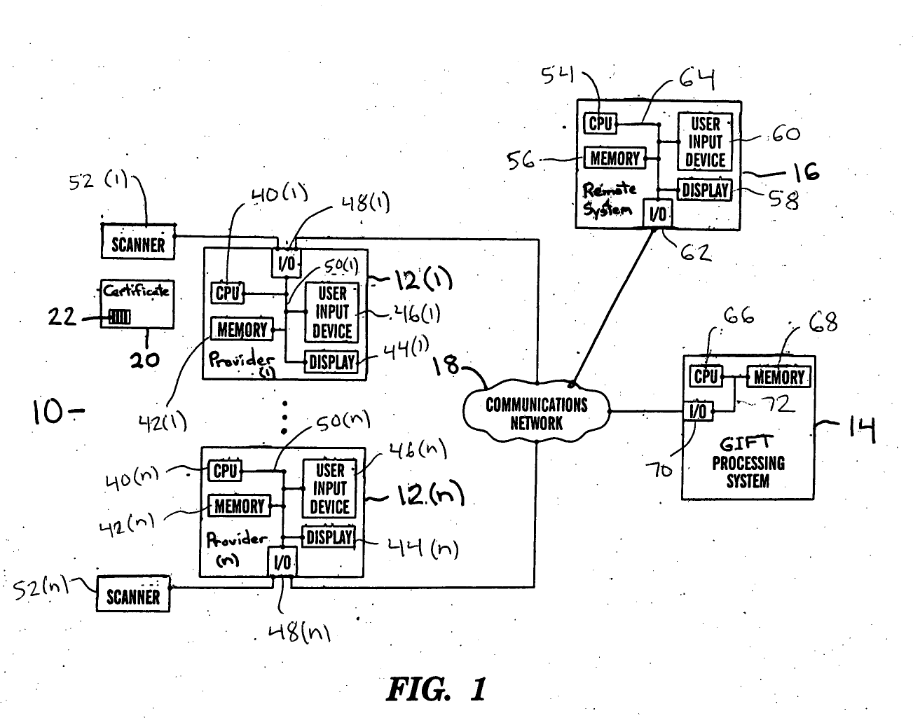

A system 10 for giving a gift in accordance with embodiments of the present invention is illustrated in FIG. 1. The system 10 includes a plurality of provider systems 12(1)-12(n), a gift processing system 14, a remote system 16, and a communications network 18, although the system 10 can include other types and numbers systems and devices arranged in other manners. The present invention provides a number of advantages including providing a method and system for giving a gift which provides a unique and satisfying gift giving experience for the recipient of the primary gift and one or more of the secondary gifts and helps to facilitate business at more than one of the providers of the gifts.

Referring to FIG. 1, the provider systems 12(1)-12(n) are at locations where the certificate 20 can be redeemed, such as at restaurants, wineries, chocolate specialty stores, schools, although the provider systems 12(1)-12(n) could be at other locations and other types and numbers of provider systems could be used. In this example, each of the providers has one of the provider systems 12(1)-12(n) which each include a central processing unit (CPU) or processor 40(1)-40(n), a memory 42(1)-42(n), a display 44(1)-44(n), a user input device 46(1)-46(n), and an input/output interface system 48(1)-48(n) which are coupled together by a bus or other link 50(1)-50(n), although other numbers and types of components in other configurations can be used and the providers can process requests for a primary or secondary gift in other manners with or without provider systems 12(1)-12(n).

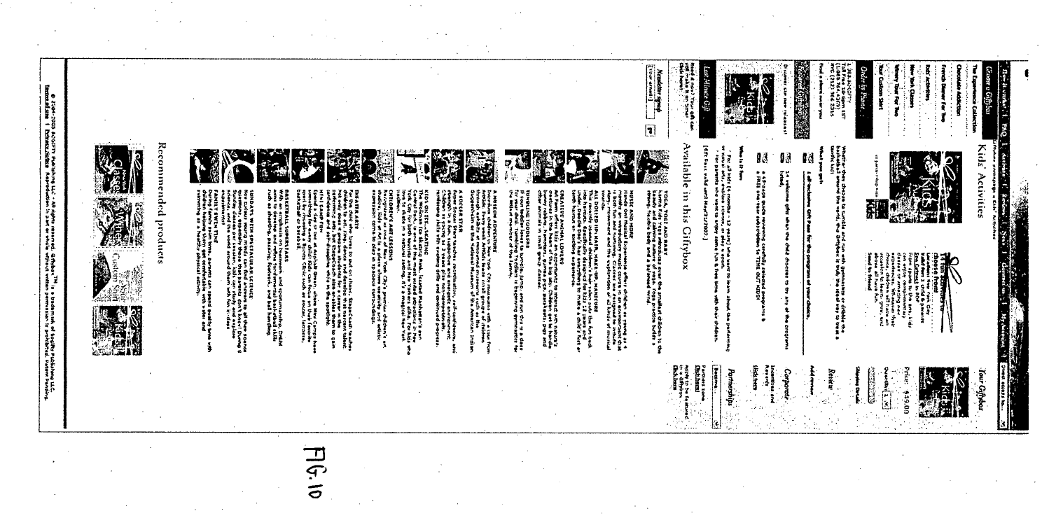

Each of the processors 40(1)-40(n) executes a program of stored instructions for one or more aspects of the present invention as described herein, including the method for giving a gift, such as a good and/or a service, as described with reference to FIG. 10, although the method could be implemented in other manners. Each of the memories 42(1)-42(n) stores these programmed instructions for one or more aspects of the present invention as described herein, although some or all of the programmed instructions could be stored and/or executed elsewhere, such as in a memory 68 a processor in gift processing system 14. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one of the processors 40(1)-40(n), can be used for each of the memories 42(1)-42(n).

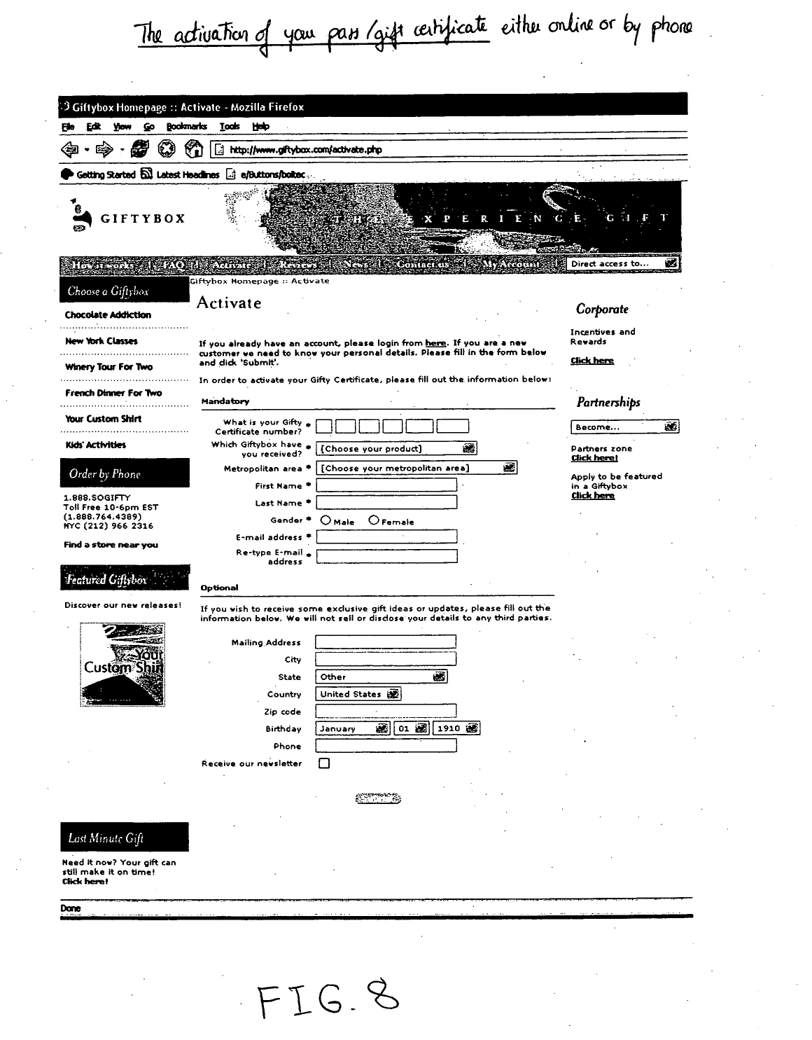

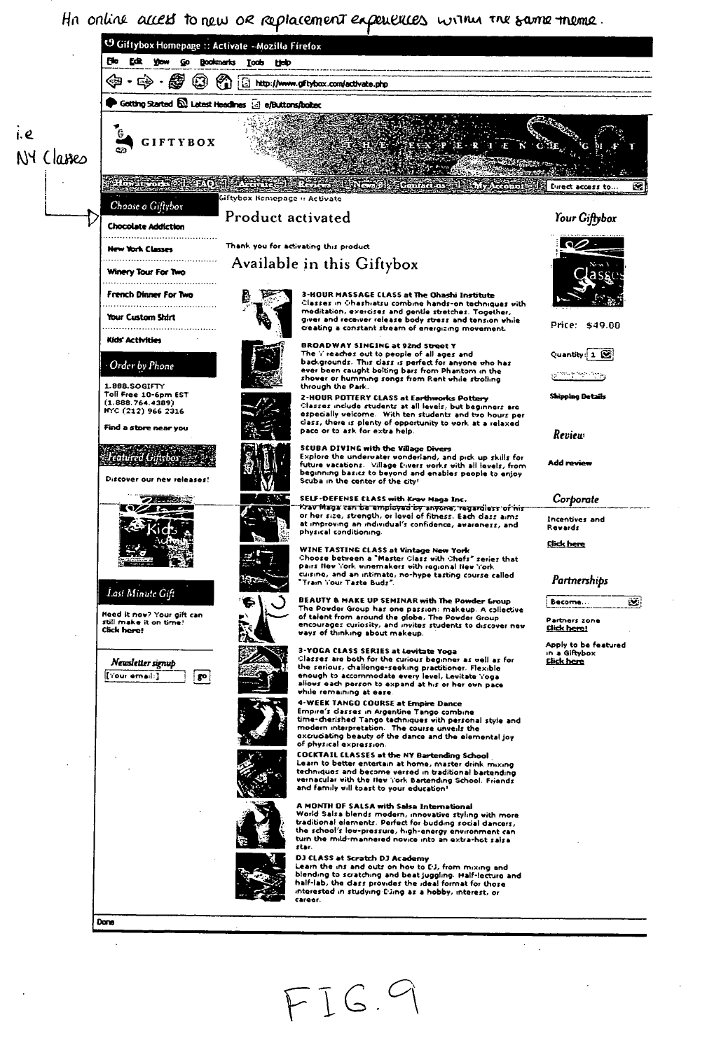

Each of the display devices 44(1)-44(n) enables an operator to see the information relating to the gift giving system and method, such as the activation screen shot in FIG. 8 and the confirmation of activation screen shot in FIG. 9. Each of the display devices 44(1)-44(n) comprises a computer screen, such as an LCD screen or a CRT display, although other types and numbers of displays could be used.

Each of the user input devices 46(1)-46(n) enables an operator to generate and transmit signals or commands to each of the processors 40(1)-40(n) relating to the gift giving system and method, such as the activation code 26 on the gift certificate 23(1). Each of the user input devices 46(1)-46(n) is a computer keyboard, although other numbers and types of user input devices can be used, such as a computer mouse.

Each of the input/output interface systems 48(1)-48(n) is used to operatively couple and communicate between the provider systems 12(1)-12(n) and other devices and systems, such as the gift processing system 14 or remote system 16. Each scanner 52(1)-52(n) is used to scan a bar code 22 on a gift certificate 20, although other ways of storing the activation data, such as an alpha numeric number, and other ways of entering the activation data, such as by one of the user input devices 46(1)-46(n) can be used.

The gift processing system 14 is used to record and track the activation and redemption of the certificate 20, although the gift processing system 14 can have other functions and other types of systems can be used for the gift processing system 14 and other manners of recording and tracking activation and redemption of the certificate can be used. For example, the gift recipient could remove the certificate from the gift booklet 23(1) and present the certificate 20 to the provider and the provider could check to verify that the certificate number is a valid combination of letter(s) and number(s) and verify the authenticity of a hologram or other identifier on the certificate 20. The gift processing system 14 includes a central processing unit (CPU) or processor 66, a memory 68, and an input/output interface system 70 which are coupled together by a bus 72 or other link, although other numbers and types of components in other configurations can be used.

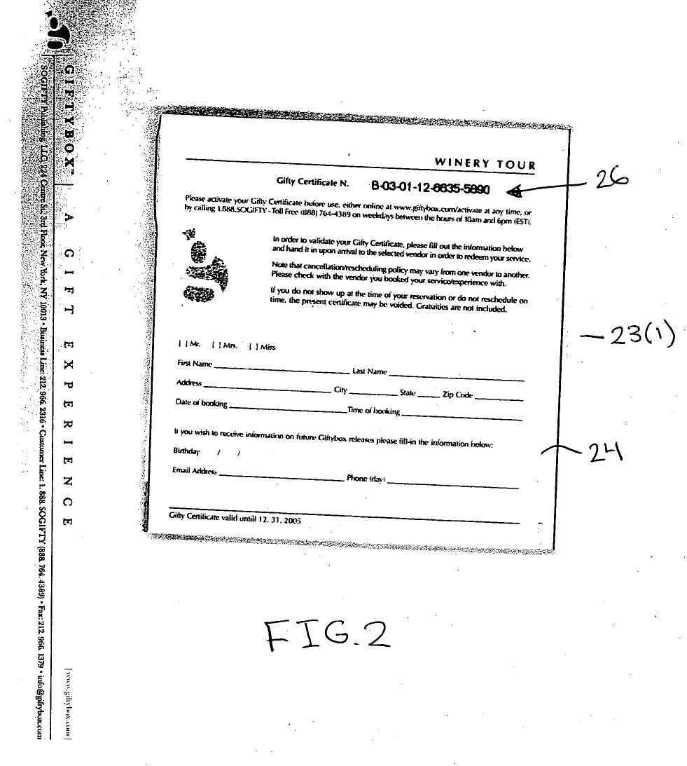

The processor 66 in the gift processing system 14 executes a program of stored instructions for one or more aspects of the present invention as described herein, including the method for providing gifts as described with reference to FIG. 2. The memory 68 stores these programmed instructions for one or more aspects of the present invention as described herein, although some or all of the programmed instructions could be stored and/or executed elsewhere, such as in one or memories of provider systems 12(1)-12(n). A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory 68 in the gift processing system 14. The input/output interface system 70 in the gift processing system 14 is used to operatively couple and communicate between the particular one of provider systems 12(1)-12(n) and other devices and systems, such as the remote system 16.

The remote system 16 is used by the recipient to activate and obtain information about the certificate 20, although the remote system 16 can have other functions and other types of systems can be used for the remote system 16. For example, the remote system 16 could be an email receiving/transmitting device where to and from the gift recipient can be sent. The remote system 16 includes a central processing unit (CPU) or processor 54, a memory 56, a display 58, a user input device 60, and an input/output interface system 62 which are coupled together by a bus 64 or other link, although other numbers and types of components in other configurations can be used.

The processor 54 in the remote system 16 executes a program of stored instructions for one or more aspects of the present invention as described herein, including the method for providing gifts as described with reference to FIG. 2. The memory 56 stores these programmed instructions for one or more aspects of the present invention as described herein, although some or all of the programmed instructions could be stored and/or executed elsewhere, such as in a memory by a processor in gift processing system 14. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory 56 in the remote system 16.

The display device 58 in the remote system 16 displays information for the operator. A variety of different types of display devices can be used for display device 58, such as a CRT display. The user input device 60 in the remote system 16 enables an operator to generate and transmit signals or commands to the processor. A variety of different types of user input devices could be used for user input device 60, such as a keyboard or computer mouse. The input/output interface system 62 in the remote system 16 is used to operatively couple and communicate between the remote system 16 and other devices and systems, such as the providers system 12(1)-12(n) and the gift processing system 14.

A variety of communication systems and/or methods can be used for the communication network 18 to operatively couple and communicate between the provider systems 12(1)-12(n), gift processing system 14, and the remote system 16, such as a direct connection, a local area network, a wide area network, the world wide web, modems and phone lines, e-mails, and wireless communication technology each having their own communications protocols.

Although described and illustrated herein as implemented in a systems 12(1)-12(n), 14, and 16, each of the systems of the present invention may be implemented on any suitable computer system or computing device. For example, the present invention may be implemented on one or more workstations, PCs, laptop computers, PDAs, handheld devices, cellular telephones, wireless devices, other computerized devices, and the like. It is to be understood that the devices and systems of the exemplary embodiments are for exemplary purposes, as many variations of the specific hardware used to implement the exemplary embodiments are possible, as will be appreciated by those skilled in the relevant art(s).

Furthermore, the systems 12(1)-12(n), 14, and 16 of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing systems or devices can be substituted for any one of the devices and systems 12(1)-12(n), 14, and 16 in any embodiment of the present invention. Accordingly, principles and advantages of distributed processing, such as redundancy, replication, and the like, also can be implemented, as desired, to increase the robustness and performance the devices and systems of the exemplary embodiments. The present invention may also be implemented on computer systems that extend across any network using any suitable interface mechanisms and communications technologies including, for example, telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for generating a model for simulating systems of reacting species, which when executed by a processor, cause the processor to carry out the steps necessary to implement the methods of the present invention. The computer readable medium may also include programmed instructions for carrying out any of the other steps described and illustrated herein with respect to the methods of the present invention.

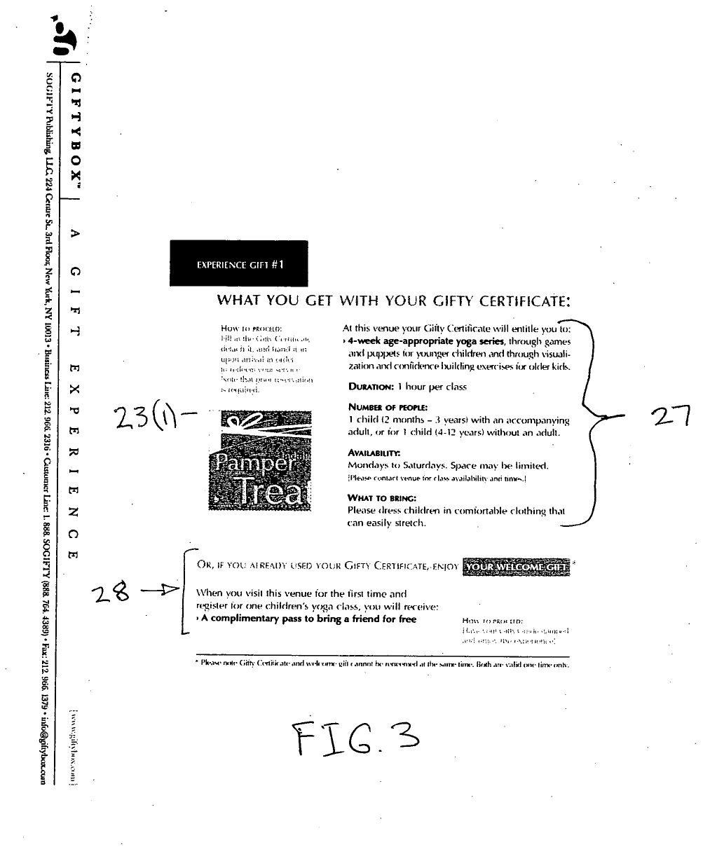

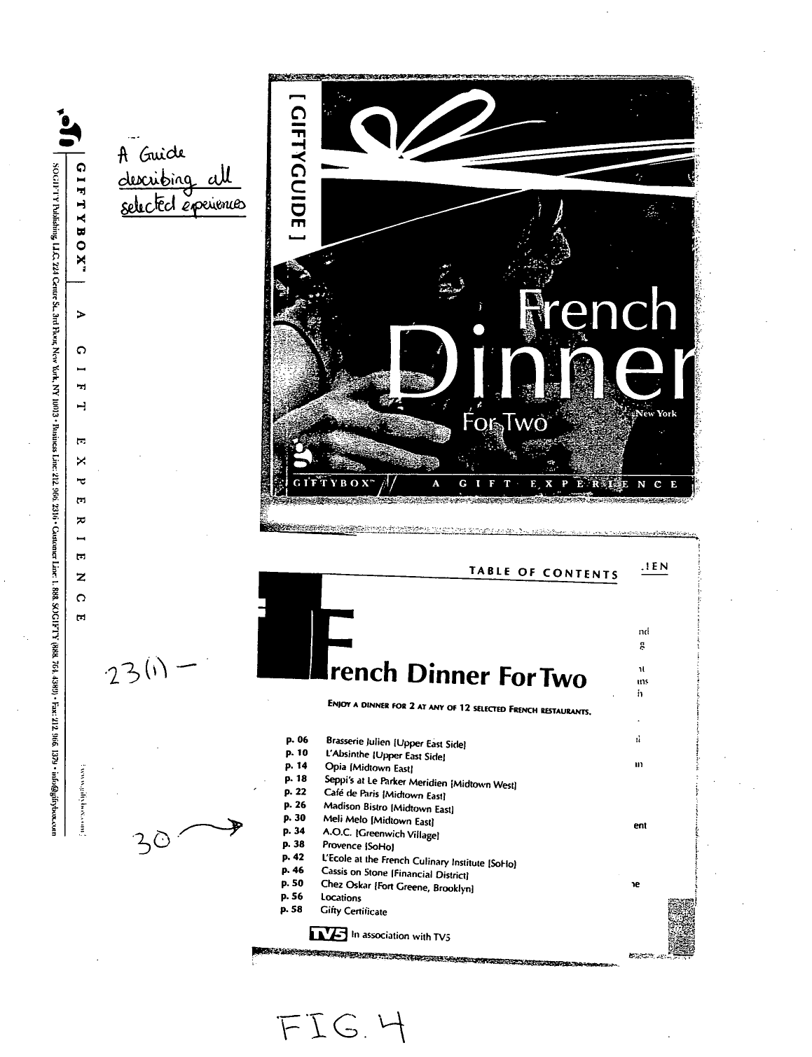

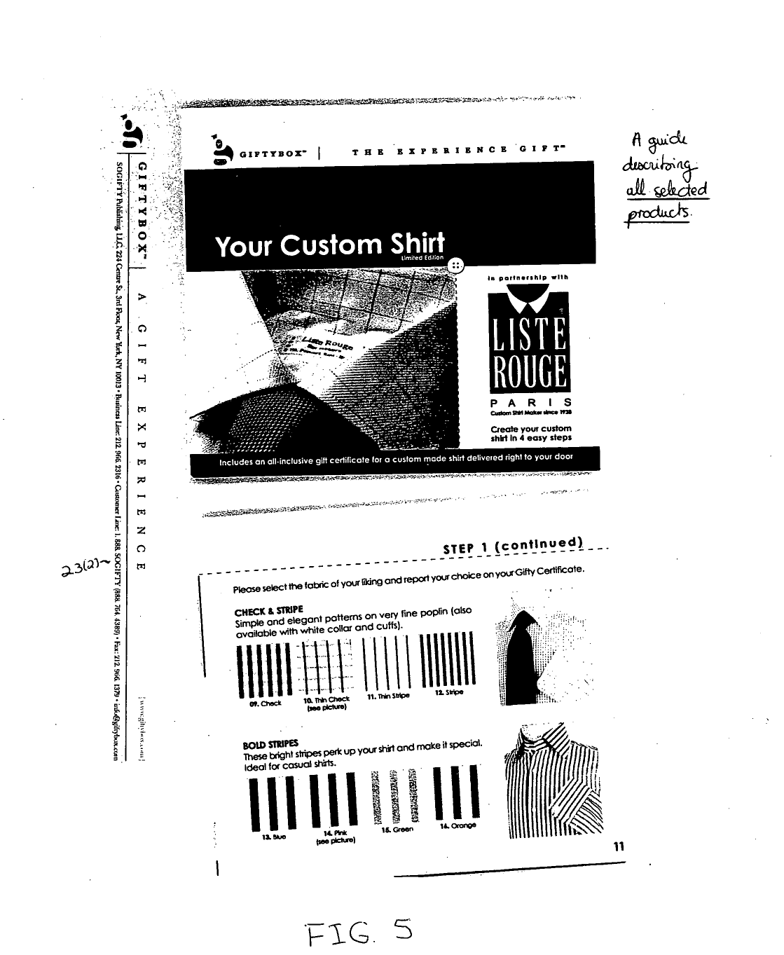

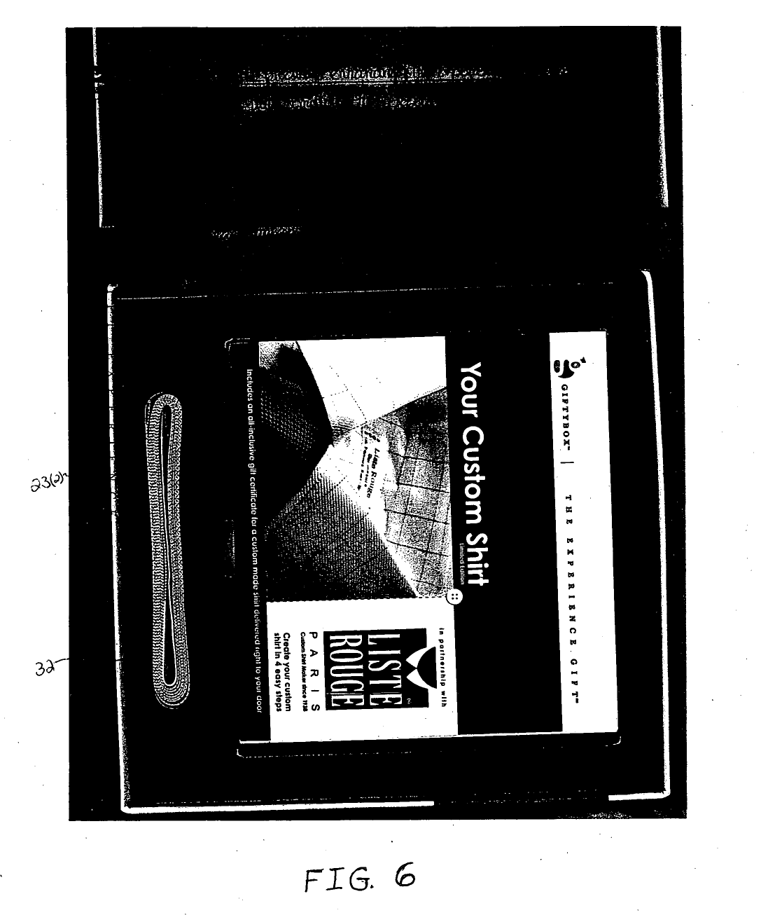

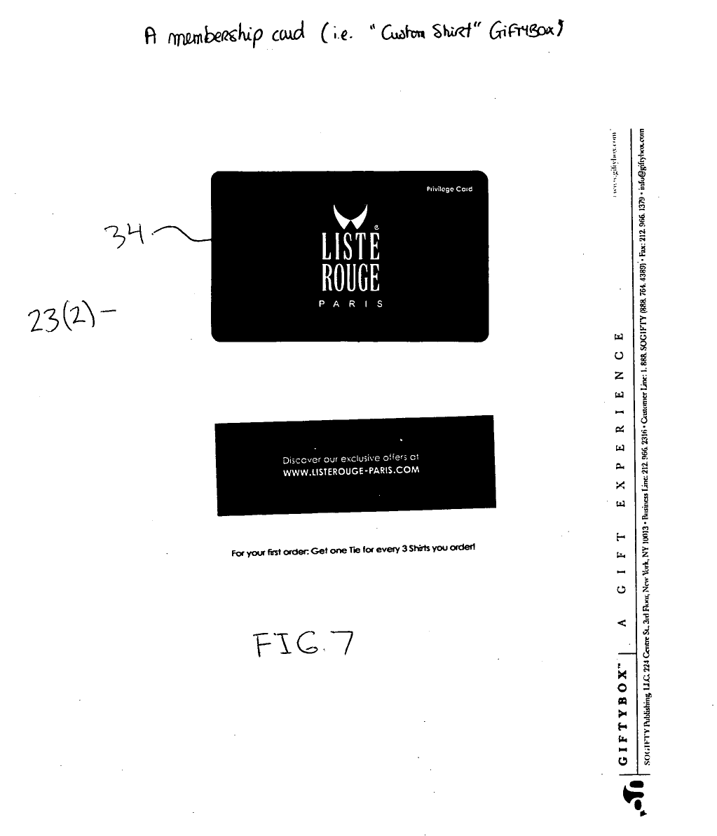

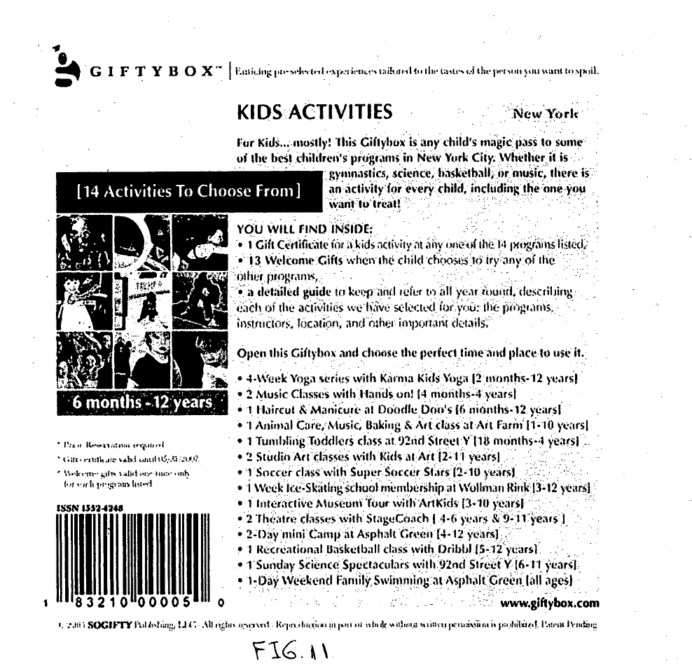

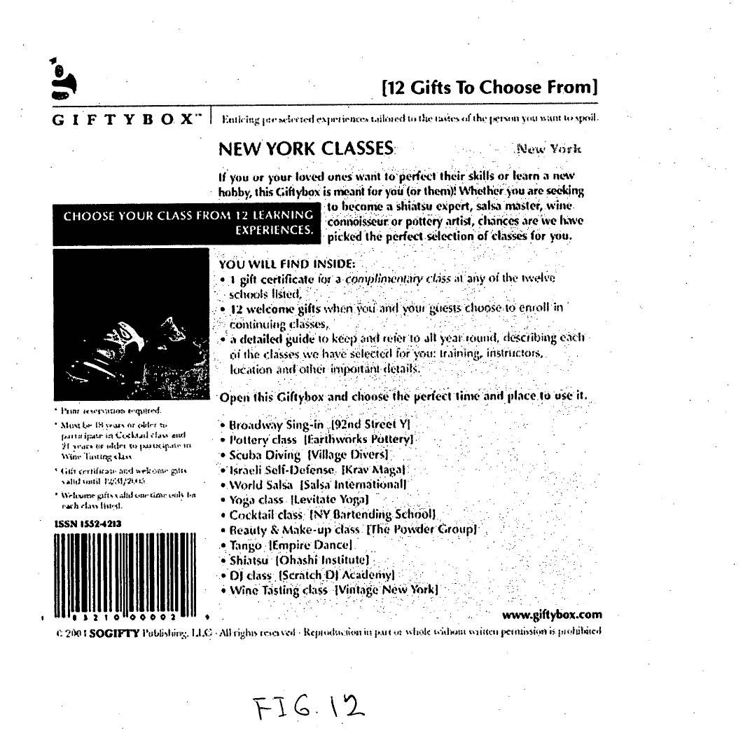

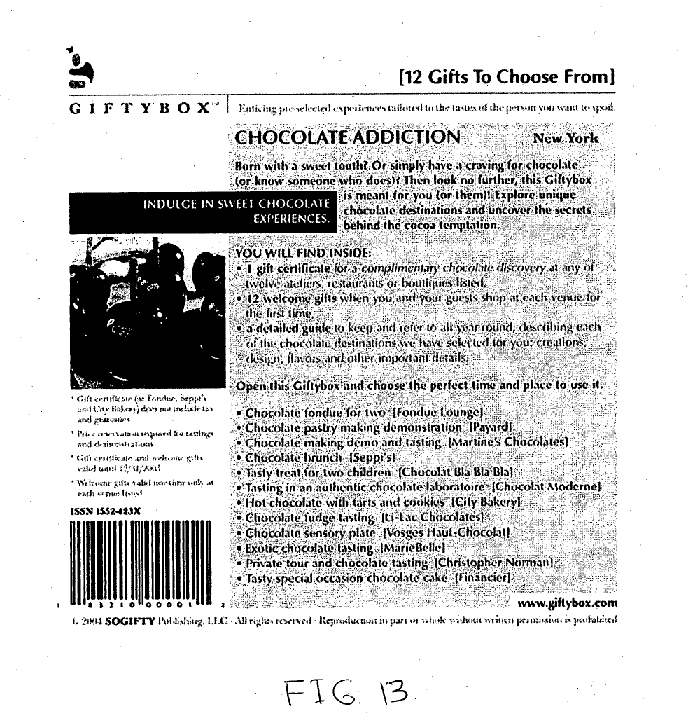

Referring to FIGS. 2-7, the gift or guide books 23(1) and 23(2) with the accompanying gift certificate 20 and 24 provide the gift recipient an option of a primary gift from one of twelve restaurants, wineries, chocolate specialty stores, or schools for classes and a secondary gift from each of the remaining providers a the provider systems 12(1)-12(n), although other numbers of options for each certificate and certificates for other types of goods and/or services with other types and numbers of primary and secondary gifts could be used. For example, a page in the guide book 23(1) with a list 30 that sets forth the options for the primary gifts is illustrated in FIG. 4, although the primary gift options can be illustrated in other manners and at other locations. By way of example, a page with a description of one of the primary gift 27 offered by a provider at one of the provider system 12(1)-12(n) is illustrated in FIG. 3. Additionally, by way of example only, descriptions of the primary gifts available in different gift packages are illustrated in FIGS. 10-13.

The secondary gift is a less substantial gift, such as a welcome gift or a discount on goods and/or services, at the other providers at the provider systems 12(1)-12(n) and is used to entice the recipient to revisit the provider of the primary gift and to visit one or more of the other providers which were not selected for the primary gift. One example of a secondary gift listing 28 in a gift or guide book 23(1) is illustrated in FIG. 3. The gift certificates 20 and 24 and the guide books 23(1) and 23(2) do not include any price information about the goods and/or services for the primary or secondary gifts.

An identifying certificate number 22 on gift certificate 20 shown in FIG. 1 or an alpha numeric activation code 26 on gift certificate 24 shown in FIG. 2 is used to individually identify and track the certificates 20 and 24, although other types of codes, such as a bar code, and other ways of identifying each certificate for activation and/or for tracking could be used.

A membership card 34 may also be provided with the guide book 23(2), although other types of cards, such as a discount card, could be provided. The membership card 34 can be associated with one or more providers and can also be provided once a primary gift is ordered from one of the providers at the provider system 12(1)-12(n).

The exemplary guide books 23(1) and 23(2) with one of the gift certificate 20 and 24 may be purchased online with a system, such as with remote system 16, over the Internet through a designated Internet sales location and is then sent to the recipient by mail, although other manners for delivery can be used, such as downloading the exemplary guide books 23(1) and 23(2) with one of the gift certificate 20 and 24 at the remote system 16.

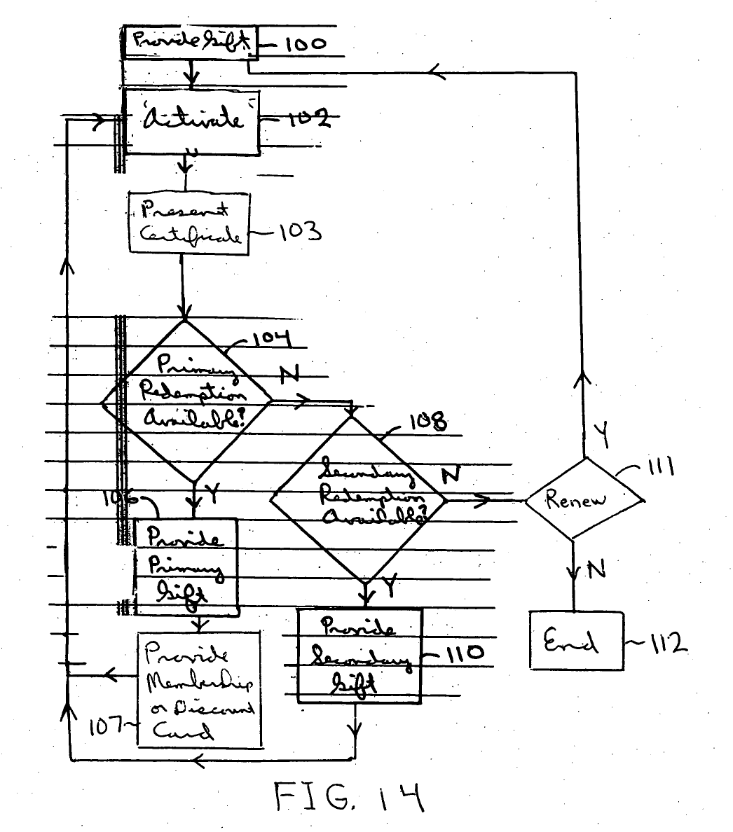

A method for providing gifts in accordance with embodiments of the present invention is illustrated in FIG. 14. In step 100, one of the gifts or gift packages comprising a guide book, such as the exemplary guide books 23(1) and 23(2), a gift certificate, such as the gift certificate 20 or 24, an experience enhancing product, such as tape measure 32, which are typically packaged in a gift box is purchased, information about the purchase is recorded. Although the gift package is described as comprising a gift box, gift certificate, an experience enhancing product, and a guide book, the gift can comprise other numbers and types of elements. The information includes the code for activation, such as the unique certificate number 22 on each certificate 20 or the activation code 26 on gift certificate 24, the purchase date, the expiration date, and information related to payment arrangements for the provider of the service, although other types of information could be recorded. The recorded information can be used to track and control use of the gift and is helpful to prevent fraud. The certificate 20 and 24 also may include other security identifiers, such as a hologram which can be examined by providers to determine authenticity of the certificate 20 or 24. Next, the purchaser gives the gift package to the gift recipient who does not know the monetary value of the primary or secondary gifts.

In step 102, the gift recipient can use the remote system 16 to activate the gift certificate 24 by entering the code 26, although other methods for activating certificates can be used, such as scanning, processing, and if verified activating the certificate 20 by scanning the bar code 22. To determine whether to activate the gift, the gift processing system 14 determines if the code for the gift certificate is valid and if it has expired, although other factors can be considered. Once the gift certificate 24 is activated, the gift processing system 14 records the activation, although the activation can be recorded in other manners, such as by an operator that receives the information.

In step 103, the recipient selects one of the primary gifts from one of the twelve providers at the provider systems 12(1)-12(n) described in the guide book and presents the certificate 24 to the selected one of the twelve providers for the primary gift, although again the certificate 24 can have other numbers of providers and the certificate 24 can be redeemed in other manners, such as through an Internet. Although a separate provider for each primary and secondary gift is disclosed, other arrangement can be used, such as a single one of the providers 12(1)-12(n) could provide all of the primary gifts and secondary gifts or the primary and secondary gifts could be split between two or more of the providers 12(1)-12(n) with one or more providers offering more than one gift.

With the present invention, a gift recipient has multiple gift options to select from that are in a particular theme, such as different types of classes, childrens activities, chocolate experiences, or shirts as disclosed in FIGS. 10-13. As a result, the gift giver, only needs to have a generalized understanding of the recipient's interests and can then provide the gift recipient with multiple gift options to select from at the recipient's discretion. Additionally, the guide book 23(1) with the certificate 24 does not include any indication of the monetary value of the primary or secondary gifts. This way the amount spent by the gift giver is kept confidential.

In step 104, the provider at one of the provider systems 12(1)-12(n) uses one of the scanners 52(1)-52(n) to scan the bar code on the certificate 20, although other manners of checking the certificate 20, such as verifying an alphanumeric number 26 on a gift certificate 24 at one of the provider systems 12(1)-12(n) with the gift processing system 14, can be used. For example, the certificate 20 may simply be redeemed by detaching the certificate 20 from the booklet and presenting it to the selected provider. The booklet and certificate 20 may also include a hologram or other security mark which the provider can examine to verify the authenticity of the booklet and certificate 20. In this example of a computerized redemption system, the one of the provider systems 12(1)-12(n) transmits the information about the scanned certificate code 22 to the gift processing system 14. The gift processing system 12 checks to see if the certificate 20 is valid and if the certificate 20 has already been used for the primary redemption. If the primary redemption is available then the gift processing system 14 transmits a signal to the one of the provider systems 12(1)-12(n) that the certificate 20 can be used and the YES branch is taken to step 106, although other manners for determining if the certificate 20 can be redeemed, such as presenting the certificate 20 to the provider and having the provider verify the authenticity of the certificate based on one or more factors, such as the certificate number and the hologram, can be used.

In step 106, the provider gives the primary gift, such as a good and/or service, to the recipient and the method proceeds back to step 107 where the gift recipient receives an optional a membership card 34, although other types of cards, such as a discount card, can be provided. The membership card 34 may be based on the primary gift selected or on the overall theme of all of the offered primary gifts. Next, the recipient can present the certificate 20 to another listed provider at another one of the provider systems 12(1)-12(n) for a secondary gift and the method returns to step 102. If the certificate 20 is removed from the booklet, then the booklet may have another code which can be used to track redemption of the secondary gift or the booklet may simply have a space provided for each provider to complete upon redemption of the secondary gift, such as an area that can be stamped or otherwise marked.

If the primary redemption is not available then the gift processing system 14 transmits a signal to the one of the provider systems 12(1)-12(n) that the certificate 20 can not be used for the primary gift and the NO branch is taken to step 108, although other manners for designating that the certificate 20 can not be redeemed can be used.

In step 108, the gift processing system 12 checks to see if the certificate 20 has already been used for the secondary redemption at the particular one of the provider systems 12(1)-12(n). The secondary redemption is for a less substantial gift, such as a welcome gift to the provider's particular goods and/or services to entice further business. If the secondary redemption is available at the particular one of the provider systems 12(1)-12(n) then the gift processing system 14 transmits a signal to the particular one of the provider systems 12(1)-12(n) that the certificate 20 can be used and the YES branch is taken to step 110, although other manners for determining if redemption of a secondary gift is still available can also be used, such as an area which is stamped in the booklet upon redemption of each secondary gift.

In step 110, the provider gives the secondary gift to the recipient and the method proceeds back to step 102 where the recipient can present the certificate 20 to another listed provider at another one of the provider systems 12(1)-12(n). If the secondary redemption is not available at the particular one of the provider systems 12(1)-12(n), then the gift processing system 14 transmits a signal to the particular one of the provider systems 12(1)-12(n) that the certificate 20 can not be used and the method goes to step 111.

In step 111, the gift recipient is offered the opportunity to purchase an additional primary and/or secondary gift for a set amount. If the processing system records receipt of the set amount, the gift is renewed for an additional primary and/or secondary gift(s). If an additional purchase or renewal is desired and/or there are other available secondary gifts, then the Yes branch is taken to step 102. If an additional purchase or renewal is not desired and there are no more available secondary gifts, then the No branch is taken to step 112 where the method ends.

Accordingly, with the present invention each provider of primary and secondary gifts gets at least one page describing the good(s) and/or service the provider offers which helps to facilitate business, although other types and amounts of information could be provided. Additionally, the present invention provides the user with a satisfying gift giving experience with primary and secondary gifts. For example, with a “Winery Tour” gift offering system with a gift certificate and guide book, a user can choose to receive a primary gift of one bottle of wine from one of twelve wineries and also can enjoy eleven tastings as a secondary gift on another visit.

The present invention provides a unique way for a gift giver to provide a gift with multiple primary and secondary gift options, without disclosure of the monetary gift amount to the recipient. The present invention also allows the gift buyer to purchase a gift on a general area of interest which helps to eliminate the possibility of a gift giver choosing the wrong specific primary ands secondary gift.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Further, the recited order of elements, steps or sequences, or the use of numbers, letters, or other designations therefore, is not intended to limit the claimed processes to any order except as may be explicitly specified in the claims. Accordingly, the invention is limited only by the following claims and equivalents thereto.

What is claimed is:

1. A method for gift giving, the method comprising:
offering a selection of at least one of a plurality of primary gifts within a set, wherein a monetary value of each of the primary gifts is not specified;
offering a selection of one or more secondary gifts, wherein each of the secondary gifts is associated with one of the primary gifts and wherein a monetary value of the secondary gift is not specified;
selecting the at least one of the plurality of primary gifts from within the set;
selecting one or more of the secondary gifts from within the set which were not associated with the selected for the primary gift; and
providing the selected primary gift and each of the one or more of the selected secondary gifts.

2. The method as set forth in claim 1 wherein at least two of the plurality of primary gifts are offered by different providers.

3. The method as set forth in claim 1 wherein at least two of the plurality of primary gifts are offered by the same providers.

4. The method as set forth in claim 1 further comprising offering a guide book with a description of each of the primary gifts, wherein the selecting the at least one of the plurality of primary gifts is based on the description.

5. The method as set forth in claim 4 wherein the offering the guide book with a description of each of the primary gifts, further comprises offering a description of each of the secondary gifts in the guide book, wherein the selecting one or more of the secondary gifts is based on the descriptions of the secondary gifts in the guide book.

6. The method as set forth in claim 1 wherein the providing the selected primary gift further comprises:
determining if one of the primary gifts has been provided; and
providing the selected primary gift if the determining determines that the primary gift has not been provided.

7. The method as set forth in claim 1 wherein the providing each of the one or more of the selected secondary gifts:
determining if the selected one of the secondary gifts has been provided;
providing the secondary gift if the determining determines that the selected secondary gift has not been provided.

8. The method as set forth in claim 1 further comprising
providing a plurality of the sets of primary gifts and secondary gifts; and
selecting one of the plurality of sets for the offering.

9. The method as set forth in claim 8 wherein each of the plurality of the sets comprises a related type of good or service.

10. The method as set forth in claim 1 wherein the offering further comprises providing a gift certificate associated with the offering of the primary gifts and further comprising activating the gift certificate before the selecting the at least one of the plurality of primary gifts.

11. The method as set forth in claim 10 wherein the activating the gift certificate further comprises:
determining if a code associated with the gift certificate satisfies one or more criteria; and
allowing the activating if the determining determines that the code satisfies the criteria.

12. The method as set forth in claim 11 wherein the criteria comprise at least one of a valid identification code and a valid expiration date.

13. The method as set forth in claim 1 wherein the offering further comprises providing one or more products associated with the offered primary gifts.

14. The method as set forth in claim 1 wherein the providing the selected primary gift further comprises providing at least one of a membership card and a discount card with the selected primary gift.

15. The method as set forth in claim 1 further comprising:
offering of the selection of at least one other of the plurality of primary gifts for a first amount; and
permitting the selection of at least one of the plurality of primary gifts based on receipt of the first amount.

16. A system for gift giving, the system comprising:
an offering system that offers a selection of at least one of a plurality of primary gifts within a set and a guide book with a description of each of the primary gifts, wherein a monetary value of each of the primary gifts is not specified; and
a processing system that receives the selection of at least one of the plurality of primary gifts based on the description in the guide book and determines if any of the selected primary gifts has already been provided; and
an indicator system that provides an indication that the selected at least one of the primary gifts can be provided based on the determination by the processing system that none of the primary gifts has been provided.

17. The system as set forth in claim 16 wherein the offering system offers a selection of one or more secondary gifts, wherein the guide book has a description of each of the secondary gifts and wherein a monetary value of each of the secondary gifts is not specified;
wherein the processing system receives the selection of one or more of the secondary gifts and determines if the selected one or more of the secondary gifts has been provided; and
wherein the indicator system provides an indication that the selected one or more of the secondary gifts can be provided based on the determination of the processing system that the selected one or more of the secondary gifts has not been provided.

18. The system as set forth in claim 16 further comprising another offering system that offers a plurality of the sets of primary gifts and secondary gifts for selection.

19. The system as set forth in claim 18 wherein each of the plurality of the sets comprises a related type of good or service.

20. The system as set forth in claim 1 wherein the offering system further comprises providing a gift certificate associated with the offering of the primary gifts and further comprising an activation system that activates the gift certificate before the selection of the primary gift.

21. The system as set forth in claim 20 wherein the activation system further comprises:
a determination system that determines if a code associated with the gift certificate satisfies one or more criteria; and
a signaling system that signals an activation if the determination system determines that the code satisfies the criteria.

22. The system as set forth in claim 21 wherein the criteria comprise at least one of a valid identification code and a valid expiration date.

23. The system as set forth in claim 16 wherein the offering system further comprises one or more products associated with the offered primary gifts and the guide book.

24. The system as set forth in claim 16 wherein the processing system further comprises a card distribution system that triggers the distribution of at least one of a membership card and a discount card based on the selection of the primary gift.

25. The system as set forth in claim 16 wherein the processing system further comprises a renewal system that offers another selection of at least one other of the plurality of primary gifts in the offering system for a first amount, wherein the renewal system permits the selection of at least one of the plurality of primary gifts based on receipt of the first amount.

26. A method for gift giving, the method comprising:
offering a selection of at least one of a plurality of primary gifts within a set and a guide book with a description of each of the primary gifts, wherein a monetary value of each of the primary gifts is not specified;
selecting the at least one of the plurality of primary gifts from within the set based on the description of each of the primary gifts in the guide book; and
providing the selected primary gift.

27. The method as set forth in claim 26 wherein at least two of the plurality of primary gifts are offered by different providers.

28. The method as set forth in claim 26 wherein at least two of the plurality of primary gifts are offered by the same providers.

29. The method as set forth in claim 26 wherein the providing the selected primary gift further comprises:
determining if one of the primary gifts has been provided; and
providing the selected primary gift if the determining determines that the primary gift has not been provided.

30. The method as set forth in claim 26 further comprising
providing a plurality of the sets of primary gifts; and
selecting one of the plurality of sets for the offering.

31. The method as set forth in claim 30 wherein each of the plurality of the sets comprises a related type of good or service.

32. The method as set forth in claim 26 wherein the offering further comprises providing a gift certificate associated with the offering of the primary gifts and further comprising activating the gift certificate before the selecting the at least one of the plurality of primary gifts.

33. The method as set forth in claim 32 wherein the activating the gift certificate further comprises:
determining if a code associated with the gift certificate satisfies one or more criteria; and
allowing the activating if the determining determines that the code satisfies the criteria.

34. The method as set forth in claim 33 wherein the criteria comprise at least one of a valid identification code and a valid expiration date.

35. The method as set forth in claim 26 wherein the offering further comprises providing one or more products associated with the offered primary gifts.

36. The method as set forth in claim 26 wherein the providing the selected primary gift further comprises providing at least one of a membership card and a discount card with the selected primary gift.

37. The method as set forth in claim 26 further comprising:
offering of the selection of at least one other of the plurality of primary gifts for a first amount; and
permitting the selection of at least one of the plurality of primary gifts based on receipt of the first amount.
